(19) United States
(12) Patent Application Publication
(10) Pub. No.: US 2004/0218313 A1
(43) Pub. Date: Nov. 4, 2004

(54) Combined magnetic head and fabrication method therefor

(75) Inventor: Takashi Suda, Kanagawa (JP)

Correspondence Address: SUGHRUE MION, PLLC, 2100 Pennsylvania Avenue, N.W., Washington, DC, 20037-3213, US

(73) Assignee: FUJI PHOTO FILM CO., LTD.

(21) Appl. No.: 10/835,395

(22) Filed: Apr. 30, 2004

(30) Foreign Application Priority Data
May 2, 2003 (JP) 2003-127184

(51) Int. Cl. G11B 5/127

(52) U.S. Cl. 360/317

(57) ABSTRACT

There is provided a combined magnetic head including an inductive head and an MR head, which are fabricated separately and joined together. The inductive head includes a magnetic core having a plurality of magnetic films with non-magnetic films interleaved therebetween, a coil for inducing a magnetic flux in the magnetic core, and an insulator serving as a write gap at which the magnetic flux produces a flux leakage. End faces of the magnetic films are disposed to face the write gap. Accordingly, stronger read signals can be obtained and data stored with increasing recording densities can be encoded and decoded.

### BACKGROUND OF THE INVENTION

This invention relates to a combined magnetic head having a write head for recording (writing) data onto magnetic recording media and a read head for retrieving (reading back) the recorded data from the magnetic recording media.

Catering the recent trend toward high-density recording of the magnetic recording media, such as magnetic tapes and magnetic disks, several attempts have been made to provide recording heads capable of achieving narrow write gaps and improved frequency response in high-frequency bands, so as to retrievably record (i.e., write and store) data or information in narrower tracks of such media.

Combined (dual-element) magnetic heads with magnetoresistive read elements and inductive write elements are known in the realm of magnetic disk storage technologies (e.g., Japanese Laid-Open Patent Application, Publication No. 2002-183914 A).

In such a combined magnetic head for magnetic disks, typically, a magnetoresistive element can read back information recorded as magnetization patterns on a magnetic disk irrespective of the velocity relative to the spinning disk, while an inductive element, with a magnetic core formed in thin-film layers, can have a narrower write gap width. Therefore, if the combined magnetic head is applied to a read/write head for magnetic tapes, the finer the magnetic core geometries become, the narrower-track magnetic tapes can become available. Moreover, with the magnetoresistive element employed for performing its read-back functionality, which represents high sensitivity to variations in magnetic field strength, this combined magnetic head can generate a higher level of output signals.

The inductive element of the combined magnetic head typically includes a magnetic core comprised of upper and lower magnetic pole layers magnetically connected together by a yoke around which a thin spiral coil is wound. When the spiral coil is energized, the electrical current flows through the spiral coil, and thus produces the magnetic field in the magnetic core, which in turn induces flux leakage (recording flux) in the write gap. However, this electrical current flowing through the spiral coil also produces a magnetic flux in a direction perpendicular to each magnetic pole layer, thereby generating an eddy current in the both magnetic pole layers. Disadvantageously, the eddy current, as thus generated, causes increase in inductance, which degrades the capability of the inductive element as a magnetic transducer in high-frequency bands; i.e., the increase in inductance limits the frequency with which the current reversals can occur for write operation, so that the inductive element with high inductance cannot perform its write operation at the high frequencies. This prevents the magnetic tape from having storage densities increased further.

The present invention has been made to eliminate the above-described disadvantages, and it is one exemplified object of the present invention to provide a combined magnetic head and a fabrication method therefor, in which stronger read signals can be obtained and data stored with increasing storage densities can be recorded (encoded) and retrieved (decoded).

### SUMMARY OF THE INVENTION

In one aspect of the present invention, there is provided a combined magnetic head comprising an inductive head and a magnetoresistive head. The inductive head of the combined magnetic head includes a magnetic core having a plurality of magnetic films with non-magnetic films interleaved therebetween, a coil for inducing a magnetic flux in the magnetic core, and an insulator (or insulating film) serving as a write gap at which the magnetic flux produces a flux leakage. End faces of the magnetic films are disposed to face the write gap.

In this combined magnetic head, the magnetic flux induced in the magnetic core by the coil flows through each of the magnetic films so that a flux leakage is produced at the end face thereof which faces the write gap. Since the magnetic films are laminated with the non-magnetic films interleaved therebetween, and the end faces of the magnetic films are disposed to face the write gap, the eddy current, which would otherwise be generated in the magnetic films, can be significantly reduced. Accordingly, this combined magnetic head can greatly reduce deterioration of the capability of an inductive write element thereof (i.e., inductive head) as a magnetic transducer in high-frequency bands, thus maintaining the frequency characteristic even in the high-frequency bands. This removes impediments to the increase in the recording densities of magnetic tapes, and thus, magnetic tapes of further increased recording densities can be made available. Moreover, since this combined magnetic head is provided with a magnetoresistive element, a significant increase can occur in signal output.

Preferably, the above coil may be a thin-film coil. More preferably, the coil may be formed by photolithography. The thin-film photolithography method used in forming (or patterning) the thin-film coil allows line widths and spaces thereof to decrease, and makes the wire finer than that of a coil made by winding a wire into a spiral shape. Therefore, the number of turns of the coil can be considerably increased. Moreover, the insulation defects in the coil can be obviated without fail.

The above magnetic core may preferably be made of sendust, which is a high magnetic permeability material and preferred in high-frequency recording application.

A magnetoresistive element of the above magnetoresistive head may be, but not limited to, one selected from the group consisting of an anisotropic magnetoresistive (AMR) film, a spin-valve (or giant magnetoresistive: GMR) film, and a tunneling magnetoresistive (TMR) film. In other words, the magnetoresistive elements usable in implementing the present invention may include an AMR sensor, a GMR sensor, a TMR sensor, etc.

In another aspect of the present invention, there is provided a method of manufacturing a combined magnetic head, comprising the steps of: (1) fabricating a first head component, which includes forming a magnetoresistive element on a first substrate; (2) fabricating a second head component, which includes laminating a plurality of magnetic films and non-magnetic films alternately on a second substrate; and (3) joining the first head component and the second head component together.

More specifically, in the above method of manufacturing a combined magnetic head, the step (2) of fabricating the second head component may further include: (2a) forming a coil for inducing a magnetic flux in a magnetic core comprised of the laminated magnetic films; and (2b) forming an insulator serving as a write gap at which the magnetic flux produces a flux leakage, and the end faces of the magnetic films are disposed to face the write gap. Moreover, the coil may preferably be formed into a thin-film coil by photolithography, as described above.

According to the above method, the magnetic core of the above-described second head component of the combined magnetic head according to the present invention can be fabricated by laminating a plurality of magnetic films and non-magnetic films alternately on the second substrate in step (2). Further, in this method, the first head component having a magnetoresistive element formed therein and the second head component having a magnetic core formed therein are fabricated separately, and then joined together.

In a conventional method of manufacturing a combined magnetic head, an inductive head is fabricated on the prefabricated magnetoresistive head, and thus sendust (Fe—Al—Si alloy) or other high-flux materials could not be used as a material for a magnetic core, because high-temperature treatment required during the lamination process of sendust or the like for the thin-film inductive head would lower the performance of the prefabricated magnetoresistive film of the magnetoresistive head. In contrast, since the above-defined inventive method of manufacturing a combined magnetic head is designed to separately fabricate the magnetoresistive head and the magnetic core (inductive head), and thus sendust can be utilized as a material for the magnetic core. Consequently, with the method of manufacturing a combined magnetic head according to the present invention, a combined magnetic head having a magnetic core made of a high-flux material such as sendust can be fabricated, and thus a combined magnetic head for use with a magnetic tape of an increased recording density can be obtained.

The present invention further provides a helical-scan magnetic tape drive including the combined magnetic head having inventive constructions and/or manufactured by the inventive methods as discussed above.

Other advantages and further features of the present invention will become readily apparent from the following description of preferred embodiments with reference to accompanying drawings.

### BRIEF DESCRIPTION OF THE DRAWINGS

FIG. 1 is a perspective view of a combined magnetic head according to a first embodiment of the present invention.

FIG. 2 is a magnified view of the combined magnetic head of FIG. 1 for illustrating a magnetoresistive head thereof as viewed from a magnetic-tape-sliding-surface side thereof.

FIG. 3 is a sectional view of the magnetoresistive head taken along line X-X of FIG. 2.

FIG. 4 is a view of the combined magnetic head of FIG. 1 as viewed from the magnetic-tape-sliding-surface side.

FIG. 5 is a sectional view of the combined magnetic head taken along line Y-Y of FIG. 4.

FIGS. 6A-6E, 7A-7D and 8A-8C show a fabrication process of a first head component.

FIGS. 9A and 9B show a fabrication process of a second head component.

FIG. 10 is a perspective view of a combined magnetic head according to a second embodiment of the present invention.

FIG. 11 is a view of the combined magnetic head of FIG. 10 as viewed from a magnetic-tape-sliding-surface side thereof.

FIG. 12 is a sectional view of the combined magnetic head taken along line Z-Z of FIG. 11.

FIG. 13 is a graph showing frequency-response curves of the combined magnetic heads as shown in FIGS. 1 and 10.

FIG. 14A is a perspective view of a second head component for use in the combined magnetic head according to another exemplified alternative embodiment of the present invention.

FIG. 14B is a sectional view of the second head component taken along line L-L of FIG. 14A.

### DETAILED DESCRIPTION OF THE PREFERRED EMBODIMENTS

### First Embodiment

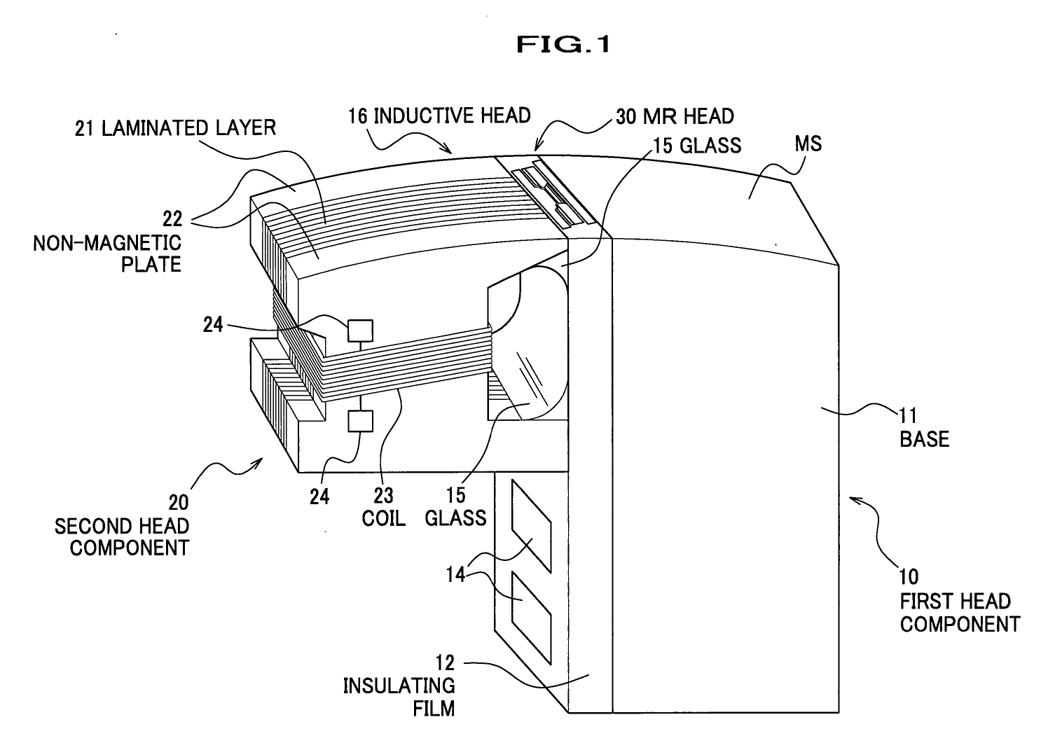

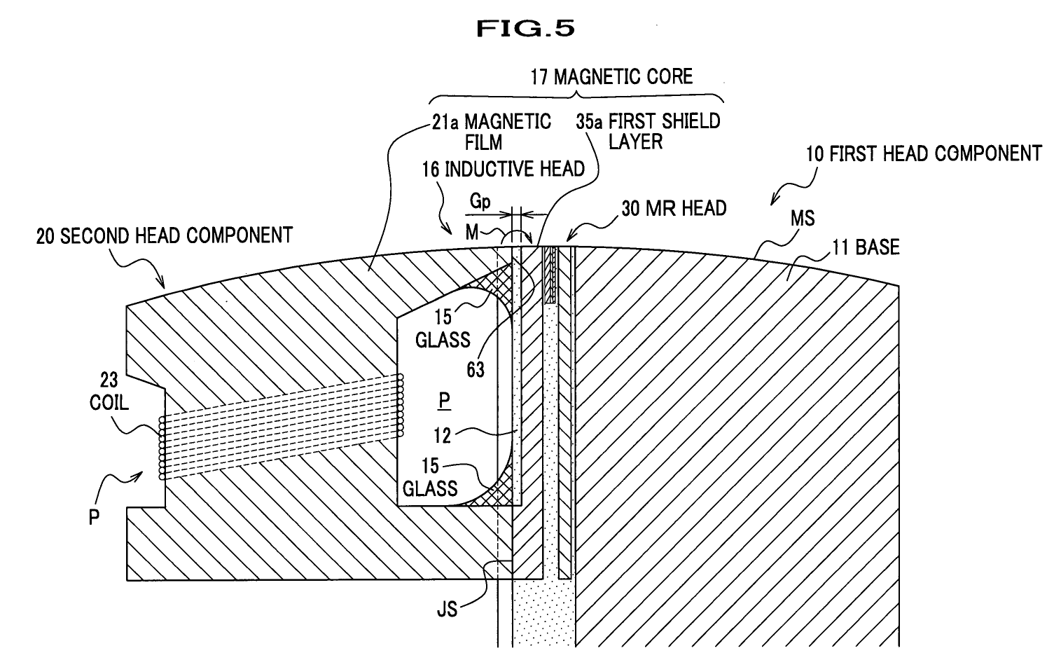

Referring now to FIGS. 1-5, a detailed description will be given of a first embodiment of the combined magnetic head according to the present invention. In the present embodiment, the combined magnetic head is a magnetic recording (read/write) head for use with a helical-scan magnetic tape drive. As shown in FIG. 1, the combined magnetic head includes a first head component 10 and a second head component 20. The first head component 10 and the second head component 20 are joined together by glass 15. Across the first head component 10 and the second head component 20 is provided a magnetic tape sliding surface MS that is curved with a predetermined curvature. For illustration purposes, the term “upper” or “top” is used to indicate the left-hand side of FIGS. 1 and 5 at which the second head component 20 is located, while the term “lower” or “bottom” is used to indicate the right-hand side of the same figures at which the first head component 10 is located.

[First Head Component]

The first head component 10 includes, as shown in FIG. 1, a base 11 made of Al₂O₃TiC (alumina titanium carbide), an insulating film 12 formed on or over a (upper) side of the base 11 facing the second head component 20, and a magnetoresistive (hereinafter referred to as “MR”) head 30 embedded in the insulating film 12 and exposed at the magnetic tape sliding surface MS.

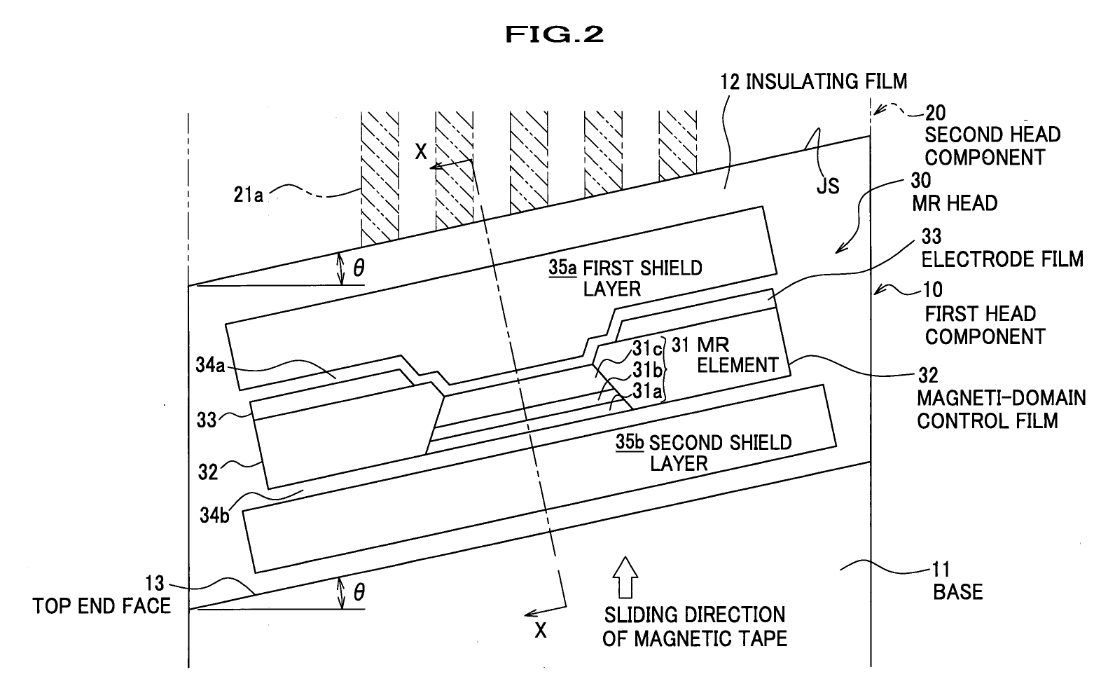

In the present embodiment, the insulating film 12, which is made of Al₂O₃ (alumina), is applied to a top end face 13 of the base 11, in such a manner that the top end face 13 bevel-faced at an angle θ is covered with a uniform thickness of the insulating film 12, as shown in FIG. 2.

The MR head 30 is a read-back head for retrieving (decoding) information recorded as,magnetic pattern on the magnetic tape. The MR head 30 includes an MR element 31, a pair of magnetic-domain control films 32 (hard films), a pair of electrode films 33, first and second separator layers 34a, 34b, and first and second shield layers 35a, 35b. The magnetic-domain control films 32 are disposed at two opposite ends of the MR element 31, so that the MR element 31 is sandwiched between the two magnetic-domain control films 32 from two opposite widthwise directions (i.e., the directions perpendicular to the sliding direction of magnetic tape). Each of the two electrode films 33 is disposed over one side (facing frontward with respect to the sliding direction of magnetic tape) of the corresponding magnetic-domain control film 32. The first and second separator layers 34a, 34b are disposed at top and bottom faces of the above assembly consisting of the MR element 31, magnetic-domain control films 32 and electrode films 33, and the first shield layer 35a and the second shield layer 35b are disposed at top and bottom faces thereof, respectively. In other words, thus-assembled MR element 31, magnetic-domain control films 32 and electrode films 33 are sandwiched between the first and second separator layers 34a, 34b, which in turn are sandwiched between the first (upper) and second (lower) shield layers 35a, 35b from upper and lower directions.

The MR element 31 includes a soft magnetic layer 31a (soft adjacent layer or SAL) of a nickel-iron-niobium (Ni—Fe—Nb) alloy formed on or over the second separator layer 34b, a non-magnetic layer 31b (SHUNT layer) of tantalum (Ta) formed on or over the soft magnetic layer 31a, and an MR film 31c of a nickel-iron (Ni—Fe) alloy (Permalloy™) formed on or over the non-magnetic layer 31b. The MR element 31 is subjected to magnetism from magnetic tape that slides along the sliding surface MS, and varies its electrical resistance as the direction of magnetization of the MR film 31c varies according to the change in the direction of magnetism on the magnetic tape.

The magnetic-domain control films 32 are made of a cobalt-chromium-platinum (Co—Cr—Pt) alloy, with magnetic bias applied to the MR film 31c, serving to reduce Barkhausen noises which would otherwise occur when the direction of magnetization of the MR film 31c varies.

The electrode films 33 are made of gold (Au), serving to supply a sense current through the magnetic-domain control films 32 to the MR element 31. The electrode films 33 are electrically connected, respectively, to electrode pads 14 for the MR head 30 provided in the first head component 10 (see FIG. 1).

The first and second separator layers 34a, 34b are made of alumina, serving to provide magnetic isolation (insulation) between the MR element 31 and the first and second shield layers 35a, 35b, respectively.

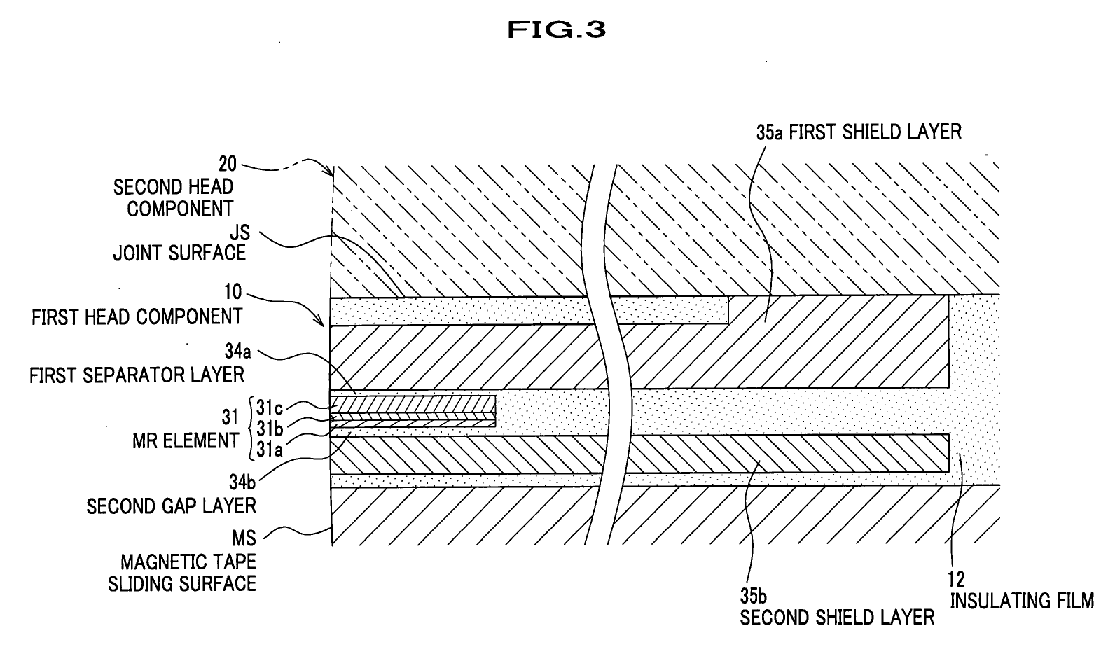

The first and second shield layers 35a, 35b are made of a nickel-iron (Ni-Fe) alloy, extending parallel to a joint surface JS formed between the first head component 10 and the second head component 20. As shown in FIG. 3, one end of the first shield layer 35a facing toward the magnetic tape is exposed at the magnetic tape sliding surface MS, and one end of the second shield layer 35b facing toward the same direction (i.e., toward the magnetic tape) is also exposed at the magnetic tape sliding surface MS. A portion near the other end of the first shield layer 35a (not of the second shield layer 35b) away from the magnetic tape sliding surface MS is exposed at a side facing toward the joint surface JS, and brought into contact with the joint surface JS across the insulating film 12.

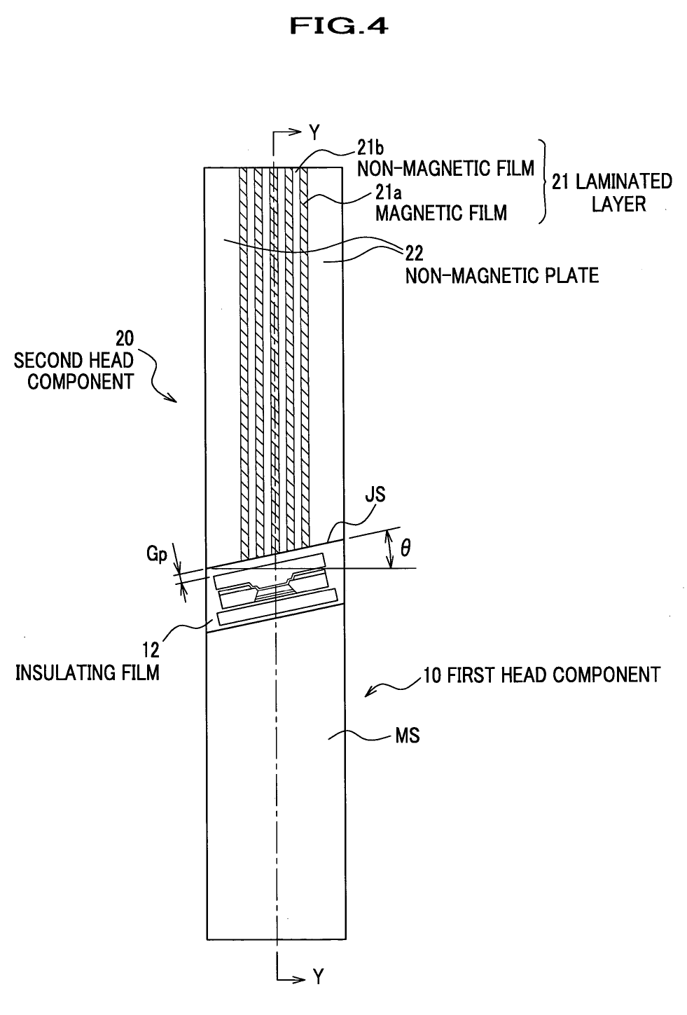

The first and second shield layers 35a, 35b are disposed over the outsides of the first and second separator layers 34a, 34b so as to sandwich the first and second separator layers 34a, 34b having the MR element 31 disposed therebetween. Thus, the highly-permeable magnetic shields formed with the first and second shield layers 35a, 35b serve to focus the magnetic energy from the tape into the MR element 31 and to reject stray fields; that is, the read-back gap with which magnetically recorded information is retrieved from the magnetic tape is determined by the first and second shield layer 35a and 35b. Moreover, the first shield layer 35a is adapted to cooperate with a magnetic film 21a (see FIG. 4) provided in the second head component 20, so that the first shield layer 35a and the magnetic film 21a constitute a magnetic core. In other words, the first shield layer 35a serves both as one of the shield layers for shielding magnetism from outside the read-back gap of the MR element 31 and as one of the magnetic pole layers (the lower magnetic pole layer) for the inductive element as will be described later.

The MR head 30 and insulating film 12 embedding the same are, as appreciated from illustration in FIG. 2, formed on the top end face 13 of the base 11 that is bevel-faced at an angle θ in such a manner that the MR head 30 embedded in the insulating film 12 is angled at θ with respect to a direction perpendicular to the sliding direction of the magnetic tape.

[Second Head Component]

Referring again to FIG. 1, it is shown that the second head component 20 includes a laminated layer 21, a pair of non-magnetic plates 22 made of alumina, and a coil 23. The laminated layer 21 is disposed between the non-magnetic plates 22, and the coil 23 is wound around the non-magnetic plates 22 between which the laminated layer 21 is sandwiched. Electric currents of which polarity varies according to binary signals read from magnetic information recorded on the traveling magnetic tape are applied to the coil 23 via electrode pads 24 for a write head 16.

The laminated layer 21 is, as shown in FIG. 4, comprised of magnetic films 21a of an Fe—Al—Si alloy (sendust) laminated in five layers and four non-magnetic films 21b of SiO₂ (silica) interleaved between the layers of the magnetic films 21a. End faces of the magnetic films 21a are in contact with the insulating film 12, which is bevel-faced at an angle θ, of the MR head 30 at the joint surface JS.

The five-layered magnetic films 21a are each formed, as shown in FIG. 5, to have two projections and one recess P therebetween at a lower side (right-hand side in FIG. 5) facing toward the first head component 10, such that one of the projections at a magnetic-tape-sliding-surface (MS) side of the magnetic films 21a tapers down toward the first head component 10, and distal end thereof as thus gradually narrowed is eventually in contact with the joint surface JS at a position opposed to the first shield layer 35a of the first head component 10 with the insulating film 12 placed therebetween. The insulating film 12 sandwiched between the magnetic films 21a and the first shield layer 35a serves as a write gap Gp (see FIG. 4) having a predetermined width with a bevel angle θ. The angle θ is adapted to conform to a predetermined azimuth angle of the magnetic head.

The other of the two projections of the magnetic films 21a has a distal end keeping magnetically in contact with the first shield layer 35a exposed at the joint surface JS of the first head component 10, so that the magnetic films 21a may serve as a magnetic pole layer for the inductive head functionality of the second head component 20. In other words, the first shield layer 35a of the first head component 10 and the magnetic films 21a of the second head component 20 are magnetically connected with each other to form a magnetic core 17.

As shown in FIGS. 1 and 5, the magnetic films 21a may also have two projections and one recess P therebetween at an upper side (left-hand side) opposite to the side facing toward the first head component 10.

As understood from FIG. 1, the non-magnetic layers 21b and non-magnetic plates 22 are also formed with the same geometries as that of the magnetic films 21a described,above, with reference to FIG. 5. The recess P formed at each side between the aforementioned two projections of the magnetic films 21a, which is also formed between two corresponding projections of the non-magnetic layers 21b and the non-magnetic plates 22, provide a portion (like a spool of a flanged bobbin) around which the coil 23 is wound.

The above-described magnetic films 21a and the first shield layer 35a are combined to form the magnetic core 17, and the magnetic core 17, write gap Gp and coil 23 constitute the inductive head 16 (write head) of the combined magnetic head according to the present embodiment.

Next, an operation of the combined magnetic head according to the present embodiment will be described. First, a process for recording magnetic information onto magnetic tape begins by application of electric current varying in polarity according to the magnetic information (binary data) to be recorded on the magnetic tape, through the electrode pads 24 for the write head 16 (see FIG. 1) to the coil 23. The coil 23, to which the electric current is applied, induces a magnetic flux in the magnetic core 17; the magnetic flux transmits through the magnetic films 21a of the laminated layer 21, and the first shield layer 35a of the MR head 30. The magnetic flux in the magnetic core 17 causes leakage (leakage flux M) at the magnetic tape sliding surface MS; to be more specific, the leakage flux M crosses (detours) over the exposed magnetic-tape-sliding-surface (MS) side of the insulating film 12 (write gap Gp) disposed between the magnetic films 21a and the first shield layer 35a (see FIG. 5). The leakage flux M reverses its direction according to the change in polarity of the electric current applied to the coil 23. By thus-varying leakage flux M, magnetic information (binary data) is recorded on the magnetic tape sliding along the magnetic tape sliding,surface MS.

This combined magnetic head has a magnetic core 17 comprised of a plurality of magnetic films 21a each separated by interleaved non-magnetic films 21b (see FIG. 4); thus, the eddy current generated in the magnetic core 17 can be considerably reduced. Accordingly, this combined magnetic head exhibits an improved frequency response in high-frequency bands, and thus permits an increased transfer rate at which magnetic information is written. Consequently, a magnetic tape of an increased recording density can be made available.

Next, a process for reading magnetic information back from magnetic tape will now be described in detail. When a sense current is fed through the electrode pads 14 for the MR head 30 (see FIG. 1) to the electrode films 33 of the MR head 30 (see FIG. 2), the sense current is passed through the magnetic-domain control films 32 to the MR element 31. On the other hand, when the MR film 31c exposed at the magnetic tape sliding surface MS is subjected to magnetism (with magnetic information recorded as variation of the magnetism) from the magnetic tape that slides along the sliding surface MS, the direction of magnetization of the MR film 31c varies according to the change in polarity of the magnetism on the magnetic tape. The MR head 30 that incorporates the MR film 31c detects electric resistance that changes in the MR film 31c according to the change of the direction of magnetization of the MR film 31c, from the change in voltage that takes place between the electrode films 33 to which a constant sense current is applied. In other words, the magnetic information (binary data) is retrieved when the varying magnetic field from the traveling magnetic tape modulates the resistance of the MR film 31c which in turn is detected as a voltage change between the electrode films 33.

Since this combined magnetic head, which includes the MR head 30 having a construction as described above, can read back magnetic information recorded on the magnetic,tape as, a modulation of electric resistance through the magnetoresistance effect, a high level of output signals can be obtained irrespective of the transport speed of the magnetic tape.

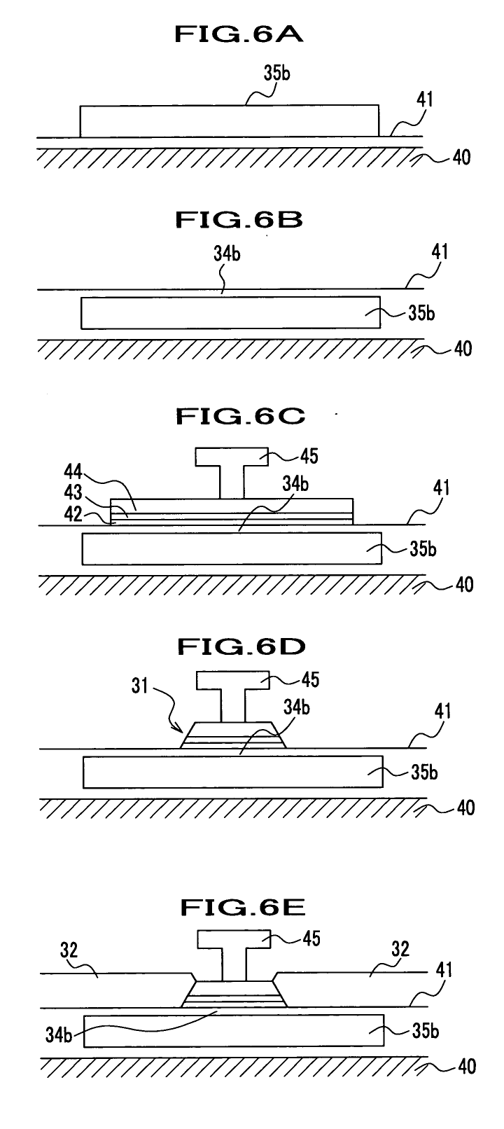

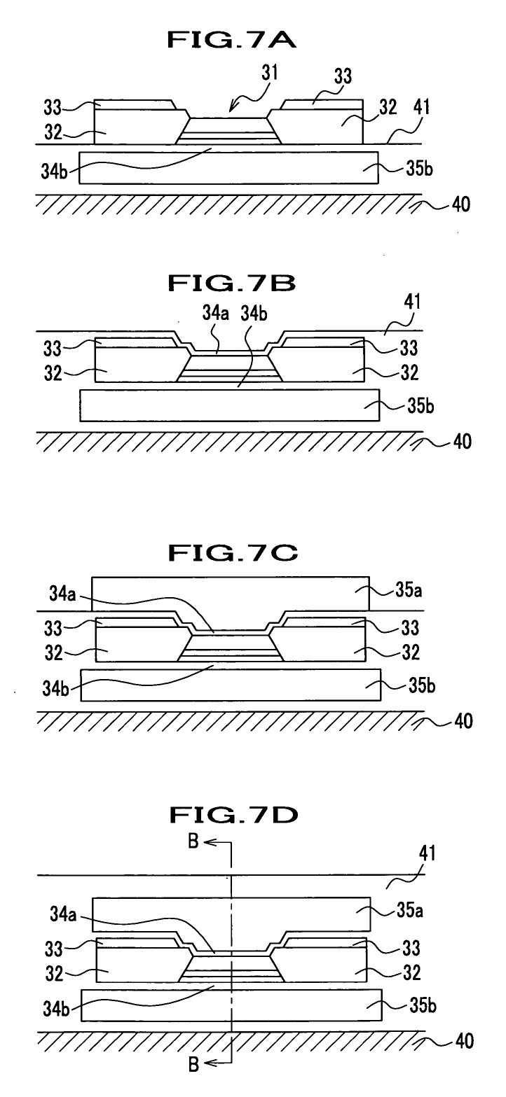

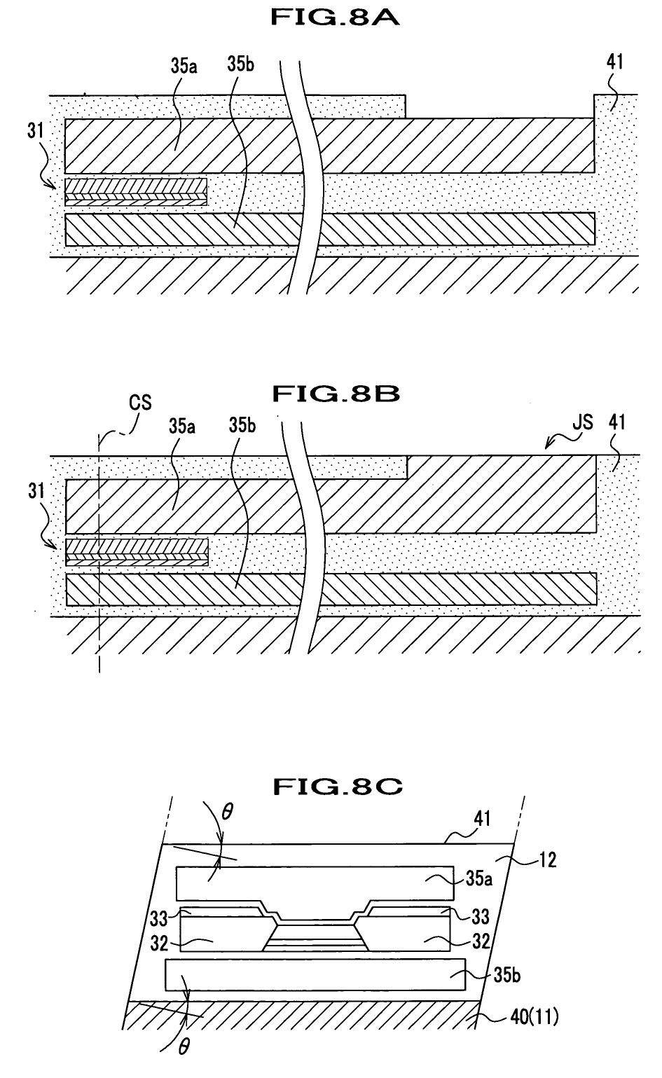

A description will be given of a fabrication method for the combined magnetic head according to the present embodiment with reference made as appropriate to the drawings. Among the drawing figures which will be referred to, FIGS. 6A-6E, 7A-7D, 8A-8C, and 9A-9B are schematic diagrams for explaining process steps of fabricating the combined magnetic head, in which FIGS. 8A and 8B are cross-sectional views taken along line B-B of FIG. 7D.

[Fabrication Process of First Head Component]

As shown in FIG. 6A, first, an alumina film 41 is laminated on a wafer 40 made of alumina titanium carbide; then, a second shield layer 35b made of a nickel-iron alloy is formed on the alumina film 41. The second shield layer 35b may be formed by photolithography or ion etching. Next, as shown in FIG. 6B, an additional alumina material is layered thereover so that the second shield layer 35b are embedded in the alumina film 41, of which a top surface is then smoothed to form a second separator layer 34b as part of the alumina film 41. The wafer 40 corresponds to the first substrate as referred to in the summary of the invention and used in defining the invention. After the second separator layer 34b of alumina is formed, the process goes to the next step that will be described below with reference to FIG. 6C.

As shown in FIG. 6C, over the alumina film 41 including the second separator layer 34b are laminated a nickel-iron-niobium alloy layer 42, a tantalum layer 43 and a Permalloy™ layer 44 in this sequence. Subsequently, a mask 45 shaped like a letter T in cross section is placed on the Permalloy™ layer 44 in such a manner that the leg of T stands upright on the Permalloy™ layer 44; thereafter, the nickel-iron-niobium alloy layer 42, tantalum layer 43 and Permalloy™ layer 44 are subjected to ion etching so that an MR element 31 having oblique surfaces at both sides is carved out, as shown in FIG. 6D.

It is understood that any techniques known in the art may be employed to form or laminate each of the layers 35b, 34b, 42, 43, 44 and alumina film 41; for example, sputtering may be performed individually with each material set as a sputtering target.

As shown in FIG. 6E, a sputtering process targeting a cobalt-chromium-platinum alloy is performed over the alumina film 41 with the mask 45 left on the Permalloy™ layer 44, so that magnetic-domain control films 32 abutting against the oblique surfaces are formed.

Next, as shown in FIG. 7A, the mask 45 is removed, and the magnetic-domain control films 32 disposed so as to sandwich the MR element 31 from the both sides are carved out into a predetermined shape by photolithography and ion etching. Thereafter, a pattern defining contours of electrode films 33 is formed over the alumina film 41 by photolithography, and a sputtering process targeting gold is performed to form the electrode films 33 laid over the magnetic-domain control films 32. Electrical wiring (not shown) is provided to the electrode films 33 for establishing electrical connection with electrode pads 14 for the MR head 30. The electrode pads 14 for the MR head 30 will be formed at a later stage and connected with the electrode films 33 through the electrical wiring.

After the electrode films 33 are formed, another alumina material is layered over the electrode films 33, as shown in FIG. 7B, so that a first separator layer 34a made of alumina is formed on the MR element 31.

Referring now to FIG. 7C, a first shield layer 35a made of a nickel-iron alloy is formed in such a manner as described above on the first separator layer 34a; thereafter, turning to FIG. 7D, an additional alumina material is layered thereover so that the first shield layer 35a are embedded in the alumina film 41 in such a manner as described above. As shown in FIG. 8A, a portion of the first shield layer 35a near an end thereof located away from the MR element 31 (at the right-hand side in FIG. 8A) is exposed by cutting away part of the alumina film 41 covering that portion of the first shield layer 35a by ion milling. Next, as shown in FIG. 8B, a nickel-iron alloy is layered on the exposed portion of the first shield layer 35a to partially thicken the first shield layer 35a up to the joint surface JS. The joint surface JS is ground so that the first shield layer 35a is partially (only at the portion near the end away from the MR element 31) exposed at the upper side (facing toward the joint surface JS) of the MR head 30. Consequently, the MR head 30 as embedded in the alumina film 41, which is illustrated in FIGS. 2 and 3 as insulating film 12, but partially exposed at the joint surface JS, is formed as shown in FIG. 8B.

Subsequently, after the top surface (joint surface JS) of the insulating film 12 and exposed first shield layer 35a is smoothed, the insulating film 12 having the MR head 30 included therein and the wafer 40 attached thereto is trimmed, as shown in FIG. 8C, so that the top (and bottom) surface of the insulating film 12 is bevel-faced at an angle θ as described above. Along a line CS (see FIG. 8B), a portion of the insulating film 12 with part of MR head 30 and wafer 40 is cut away, and a section thereof is ground so as to form a surface curved with a predetermined curvature, thereby forming a magnetic tape sliding surface MS (see FIG. 3). Next, electrode pads 14 for the MR head 30 are provided and electrically connected with the electrical wiring (not shown) which is in turn connected with the above electrode films 33 as described above; thus, the first head component 10 is finally fabricated. The first head component 10 as thus fabricated includes the insulating film 12 layered over the first shield layer, 35a at a predetermined thickness and angled at θ, thus forming a write gap Gp (see FIG. 4).

[Fabrication Process of Second Head Component]

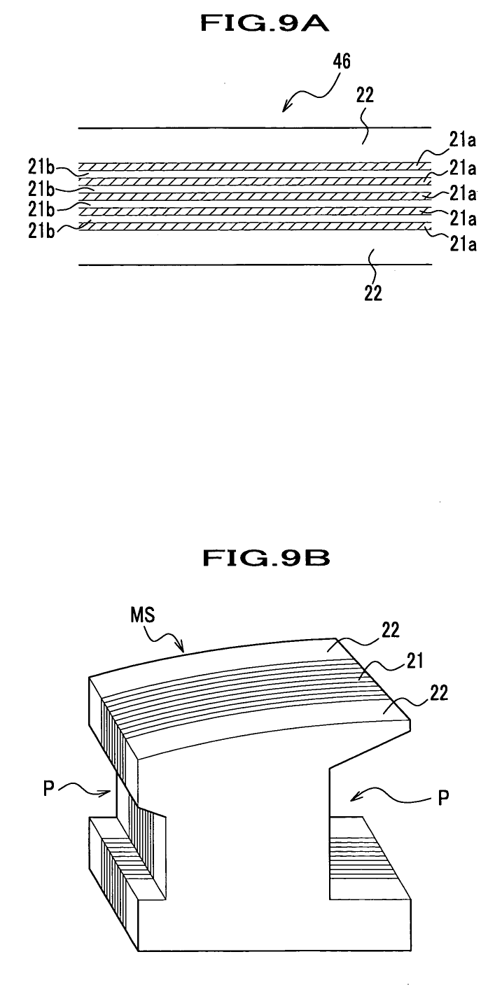

First, as shown in FIG. 9A, magnetic films 21a made of sendust in five layers each on the order of 4 μm in thickness, with non-magnetic films 21b made of silica in four layers each on the order of 0.15 μm interleaved between the layers of the magnetic films 21a, are laminated on a non-magnetic plate 22 made of alumina. The magnetic films 21a and non-magnetic films 21b may be formed individually by sputtering with each material set as a sputtering target. The non-magnetic plate 22 corresponds to the second substrate as referred to in the summary of the invention and used in defining the present invention.

Another nonmagnetic plate 22 made of alumina is placed on and joined with the fifth magnetic film 21a, with the result that a multilayer laminate 46 with a laminated layer 21 sandwiched between the two non-magnetic plates 22 is obtained. The non-magnetic plate 22 may be formed by performing a sputtering process targeting alumina.

Next, as shown in FIG. 9B, the multilayer laminate 46 is cut so as to form a magnetic tape sliding surface MS and recesses P which provide in a midsection thereof a portion (like a spool of a flanged bobbin) around which the coil 23 is wound. After the coil 23 of a predetermined number of turns is wound around the spool-like portion, electrode pads 24 for the write head 16 are provided and electrically connected with the coil 23; thus, the second head component 20 is finally fabricated.

[Fabrication Process of Combined Magnetic Head]

The first head component 10 and the second head component 20 are properly positioned so that the magnetic tape sliding surfaces MS provided on the first and second head components 10, 20 are flush with each other and curved so smoothly as to have a predetermined curvature. Upon positioning the first and second head components 10, 20, the first shield layer 35a of the first head component 10 is opposed to the laminated layer 21 of the second head component 20 across the write gap Gp. Moreover, the first shield layer 35a exposed at the joint surface JS of the first head component 10 is magnetically connected with the magnetic films 21a of the second head component 20.

The first and second head components 10 and 20 as thus positioned are bonded with each other by molten glass, and the joined magnetic tape sliding surface MS is ground; thereby a combined magnetic head according to the present embodiment is finally obtained.

In the fabrication method for a combined magnetic head as described above, unlike a method for fabricating a conventional magnetic head, in which thin-film elements are laminated on a wafer to fabricate a read-back head (MR head), and thin-film elements are further laminated on the read-back head to fabricate a write head (inductive head), the first head component 10 with MR head 30 and the second head component 20 with magnetic core 17 are fabricated separately, and joined together to form the combined magnetic head. Accordingly, a high-permeability (high flux or high magnetic induction) material such as sendust, which conventionally could not be employed as a material for a magnetic core because high-temperature treatment during the lamination process for the thin-film inductive head would lower the performance of the prefabricated MR film 31c, can be utilized in the fabrication method for the combined magnetic head according to the present embodiment. Consequently, with the fabrication method for the combined magnetic head according to the present embodiment, a combined magnetic head having a magnetic core made of a high-flux material such as sendust can be fabricated, and thus a combined magnetic head for use with a magnetic tape of an increased recording density can be obtained.

### Second Embodiment

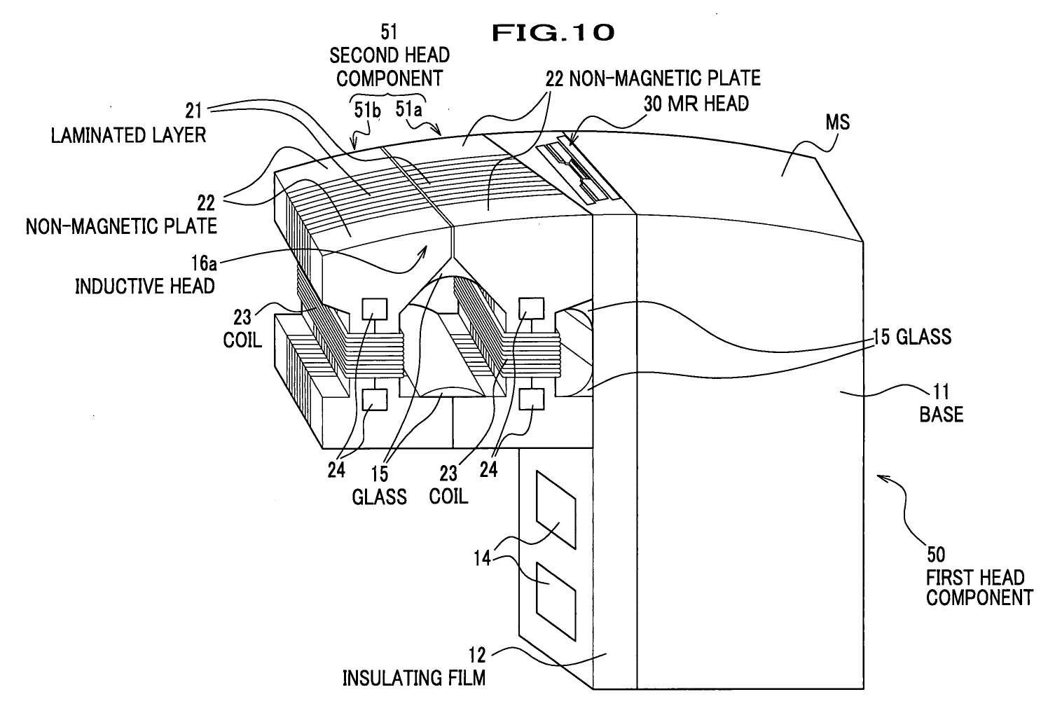

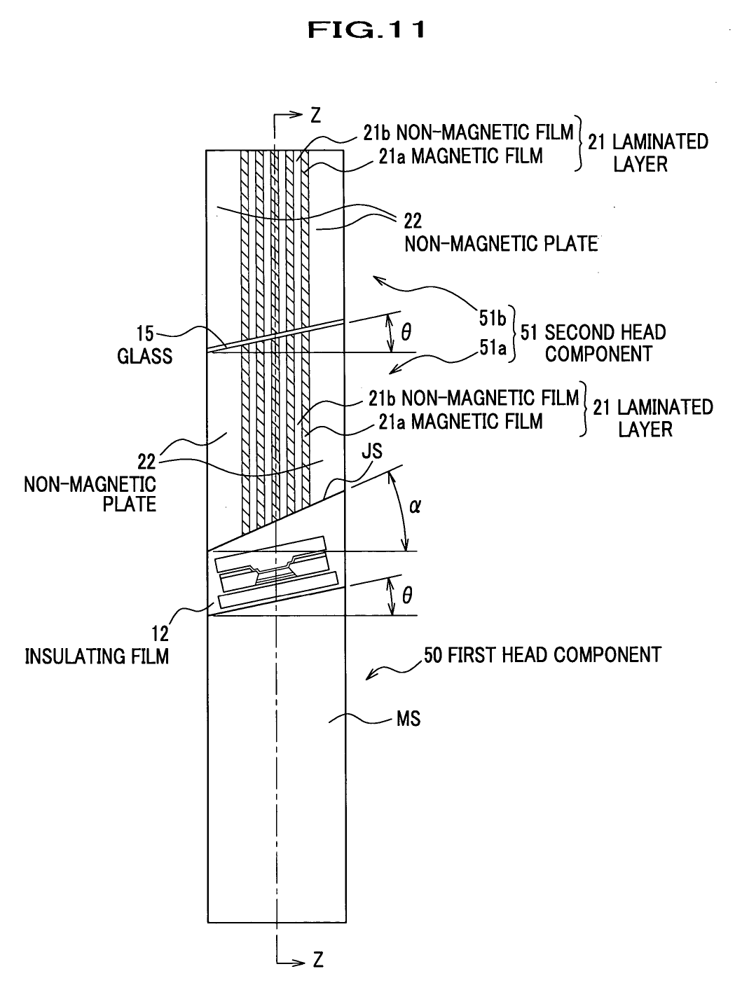

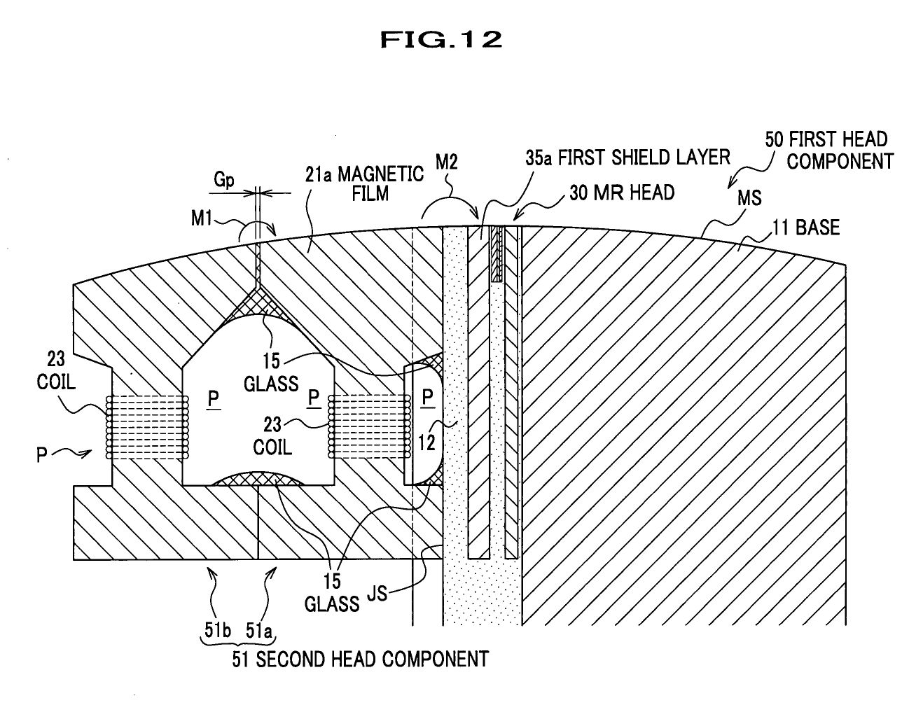

A detailed description will be given of a second embodiment of the combined magnetic head according to the present invention with reference made as appropriate to the drawings, particularly to FIGS. 10-12. In the following description, the elements similar to those of the first embodiment are designated by the same reference numerals as used in the first embodiment, and no reduplicate explanation will be given thereof. Among the drawing figures which will be referred to, FIG. 10 is a perspective view of a combined magnetic head according to the second embodiment, FIG. 11 is a view of the combined magnetic head of FIG. 10 as viewed from a magnetic-tape-sliding-surface side thereof, and FIG. 12 is a sectional view taken along line Z-Z of FIG. 11.

In the present embodiment, the combined magnetic head is, as in the first embodiment, a magnetic recording (read/write) head for use with a helical-scan magnetic tape drive. As shown in FIG. 10, the combined magnetic head includes a first head component 50 and a second head component 51. The first head component 50 and the second head component 51 are joined together by glass 15. Across the first head component 50 and the second head component 51 is provided a magnetic tape sliding surface MS that is curved with a predetermined curvature.

[First Head Component]

As shown in FIG. 11, the first head component 50 has substantially the same construction as that of the corresponding component 10 (see FIG. 2) in the first embodiment, and the MR head 30 of the first head component 50 is formed over the top end face 13 of the base 11 that is bevel-faced at an angle θ, in such a manner that the MR head 30 is angled at θ with respect to a direction perpendicular to the sliding direction of the magnetic tape. The construction of the first head component 50 according to the second embodiment is however the same as that of the first head component 10 used in the first embodiment except that the joint surface JS with the second head component 51 is bevel-faced at an angle a different from the above angle θ, and that a portion of the first shield layer 35a near one end thereof located away from the magnetic tape sliding surface MS is not exposed at a side facing toward the joint surface JS but magnetically insulated by the insulating film 12, as shown in FIG. 12.

[Second Head Component]

The second head component 51 used in the combined magnetic head according to the present embodiment is, as shown in FIG. 10, joined with the first head component 50 by glass 15, and its joint surface JS is angled at angle α as shown in FIG. 11.

The second head component 51 is, as shown in FIG. 10, comprised of a component 51a and a component 51b that are joined together by glass 15 when viewed from a magnetic-tape-sliding-surface (MS) side, and its joint surface is angled at the same angle θ (see FIG. 11) as of the MR head 30.

Each component 51a, 51b of the second head component 51, as of the second head component 20 used in the first embodiment (see FIG. 1), includes a laminated layer 21, a pair of non-magnetic plates 22, and a coil 23. The laminated layer 21 is disposed between the non-magnetic plates 22. The non-magnetic plates 22, with laminated, layer 21 sandwiched therebetween, of the components 51a and 51b assume substantially the same geometric topology and each shaped like a flanged bobbin in its entirety, and the coil 23 is wound around a spool-like portion in the midsection of the non-magnetic plates between which the laminated layer 21 is sandwiched. The laminated layer 21 is, as shown in FIG. 11, comprised of magnetic films 21a laminated in five layers and four non-magnetic films 21b interleaved between the layers of the magnetic films 21a.

The components 51a and 51b of the second head component 51 are disposed to face each other at two end faces (of the projections of their flanged bobbin-like shape) of each component 51a, 51b facing toward opposite directions; i.e., the end faces of the projections near the magnetic tape sliding surface MS of the magnetic films 21a of the component 51a and those of the magnetic films 21a of the component 51b are butted against and joined with each other via a uniform thickness of film of glass 15, while the end faces of the projections away from the magnetic tape sliding surface MS of the magnetic films 21a of the component 51a and those of the magnetic films 21a of the component 51b are directly butted against and joined with each other without insulation so that the magnetic films 21a of the components 51a and 51b are magnetically connected with each other. Accordingly, the magnetic films 21a of the components 51a and 51b of the second head component 51 form a magnetic core, and the film of glass 15 sandwiched between the opposed magnetic films 21a serves as a write gap Gp.

The magnetic core made up of the magnetic films 21a of the both components 51a and 51b of the second head component 51, together with the glass (as an insulator serving as the magnetic gap Gp) and the coil 23, constitute the inductive head 16a (write head), of the combined magnetic head according to the present embodiment.

Next, an operation of the combined magnetic head according to the present embodiment will be described. First, a process for recording magnetic information onto magnetic tape begins by application of the electric current, as described above for the first embodiment, through the electrode pads 24 for the write head 16 of the components 51a and 51b of the second head component 51 (see FIG. 10) to the coils 23. The coils 23, to which the electric current is applied, induce a magnetic flux in the magnetic core; the magnetic flux transmits through the magnetic films 21a of the components 51a and 51b of the second head component 51. The magnetic flux in the magnetic core causes leakage (leakage flux M1) at the magnetic tape sliding surface MS; to be more specific, the leakage flux M1 crosses (detours) over the glass film 15 (write gap Gp) disposed between the magnetic films 21a of the components 51 a and 51b of the second head component 51 (see FIG. 12). The leakage flux Ml allows magnetic information (binary data) to be recorded on the magnetic tape sliding along the magnetic tape sliding surface MS.

This combined magnetic head has a magnetic core comprised of a plurality of magnetic films 21a each separated by interleaved non-magnetic films 21b; thus, the eddy current generated in the magnetic core can be considerably reduced. Accordingly, this combined magnetic head exhibits an improved frequency response in high-frequency bands, and thus permits an increased transfer rate at which magnetic information is written. Consequently, a magnetic tape of an increased recording density can be made available.

Apprehensions may be aroused about a possible pseudo-write gap apparently formed by the insulating film 12 between the first shield layer 35a of the first head component 50 and the magnetic films 21a of the second head component 51 (51a) at the magnetic tape sliding surface MS, which pseudo-gap could be alleged to generate such an interfering leakage flux M2 (see FIG. 12) as would operate to record an interfering signal (noise) on the magnetic tape. According to the combined magnetic head in the present embodiment, however, the joint surface JS at which the first head component 50 is in contact with the second head component 51 (51a) is angled at α, which is an angle different from the azimuth angle θ. Therefore, such a noise, which would otherwise be incorporated into a series of data signals retrieved (read back) by this combined magnetic head from the magnetic tape, can be suppressed. It is understood that the process for reading magnetic information back from the magnetic tape may be performed by following the process steps as described above for the first embodiment.

Hereafter, a description will be given of a fabrication method for the combined magnetic head according to the present embodiment with reference made as appropriate to the drawings.

[Fabrication Process of First Head Component]

The first head component 50 may be fabricated by forming on the base 11 (see FIG. 10) an insulating film 12 with an MR head 30 embedded therein, in the same way as in the first embodiment. It is to be noted that the first shield layer 35a does not have to be exposed at the joint surface JS, and that the insulating film 12 with MR head 30 embedded therein may be trimmed so that the joint surface JS is eventually bevel-faced at an angle α, as shown in FIG. 11.

[Fabrication Process of Second Head Component]

First, following the process steps as in the first embodiment (see FIG. 9A), a multilayer laminate 46 is fabricated. Next, the multilayer laminate 46 is cut so as to form a magnetic tape sliding surface MS and recesses P which provide in a midsection thereof a portion (like a spool of a flanged bobbin) around which the coil 23 is wound, so as to make the, multilayer laminate 46 into a flanged bobbin-like shape (see FIG. 9B); thereafter, the coil 23 of a predetermined number of turns is wound around the spool-like portion, and electrode pads 24 for write head are provided and electrically connected with the coil 23, as described above for the first embodiment. In this way, the components 51a and 5 1b of the second head component 51 are fabricated, respectively.

Subsequently, one of the end faces of the component 51a located at the magnetic-tape-sliding-surface (MS) side thereof and one of the end faces of the component 51b located at the magnetic-tape-sliding-surface (MS) side thereof are disposed to face each other and joined together via a uniform thickness of the film of glass 15 so that the end faces of the magnetic films 21a are opposed to each other across the film of glass 15. On the other hand, the other of the end faces of the component 51a located away from the magnetic tape sliding surface MS and the other of the end faces of the component 51b located away from the magnetic tape sliding surface MS are butted against and joined with each other so that the magnetic films 21a of the components 51a and 51b are magnetically connected with each other. Consequently, the second head component 51 is finally fabricated.

[Fabrication Process of Combined Magnetic Head]

The first head component 50 and the second head component 51 are properly positioned so that the magnetic tape sliding surfaces MS provided on the first and second head components 50, 51 are flush with each other and curved so smoothly as to have a predetermined curvature. Then, the first and second head components 50 and 51 as thus positioned are bonded with each other by molten glass, and the joined magnetic tape sliding surface MS is ground; thereby a combined magnetic head according to the present embodiment is finally obtained.

In the fabrication method for a combined magnetic head as described above, sendust, which conventionally could not be employed as a material for a magnetic core, can be utilized as in the first embodiment. Consequently, with the fabrication method for the combined magnetic head according to the present embodiment, a combined magnetic head having a magnetic core made of a high-permeability (high flux or high magnetic induction) material such as sendust can be fabricated, and thus a combined magnetic head for use with a magnetic tape of an increased recording density can be obtained.

(Evaluations of Combined Magnetic Head)

A test for technical evaluations of the combined magnetic head according to the present invention was carried out on frequency characteristics thereof. The test was conducted by using the above-described combined magnetic heads according to the first and second embodiments. For purposes of comparison, a conventional combined magnetic head having a MIG (Metal-In-Gap) write head and an MR read head is adopted as a comparative example.

In the test, the transport velocity of magnetic tape relative to each combined magnetic head was set at 5 m/s, and rectangular-wave signals falling within the frequency range of 11 MHz to 17 MHz were fed to the inductive write head of each combined magnetic head to allow the combined magnetic head to record magnetic information on the magnetic tape.

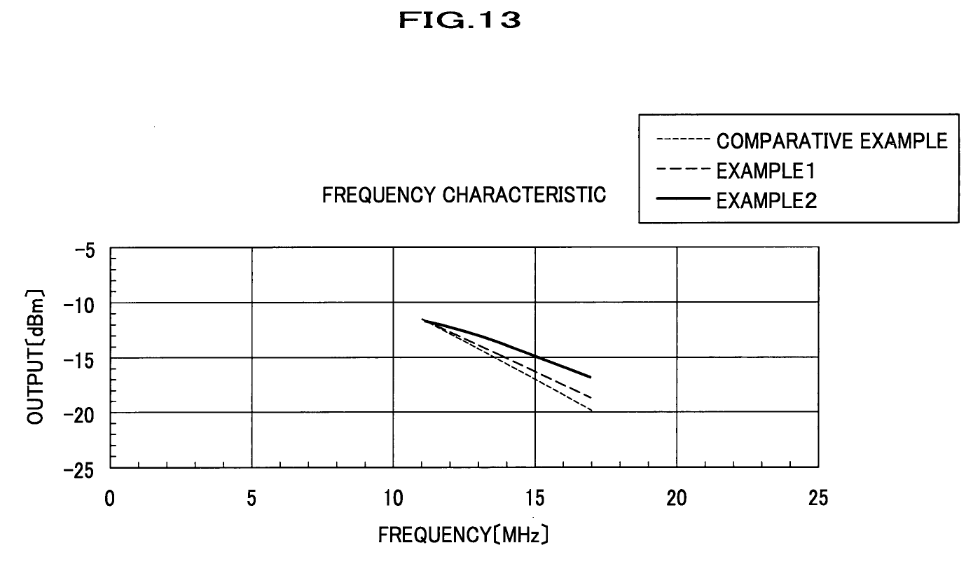

Next, the magnetic information recorded on the magnetic tape was retrieved by the MR read head of each combined magnetic head, and the outputs (dBm) were measured and plotted on the frequency-response curve as presented in a graphical form in FIG. 13. In the graph of FIG. 13, the outputs according to the first embodiment of the present invention is represented by a thick and long dashed line (EXAMPLE 1), the outputs according to the second embodiment of the present invention is represented by a thick solid line (EXAMPLE 2), and the outputs according to the conventional device is represented by a thin and short dashed line (COMPARATIVE EXAMPLE).

As evident from the representation of FIG. 13, the combined magnetic heads according to the present invention are superior in frequency characteristics to the conventional combined magnetic head having an MIG write head. It is also shown that the superiority of the combined magnetic heads according to the present invention becomes more outstanding as the frequencies of the input signals increase higher.

Although the preferred embodiments of the present invention have been described above, various modifications and changes may be made in the present invention without departing from the spirit and scope thereof.

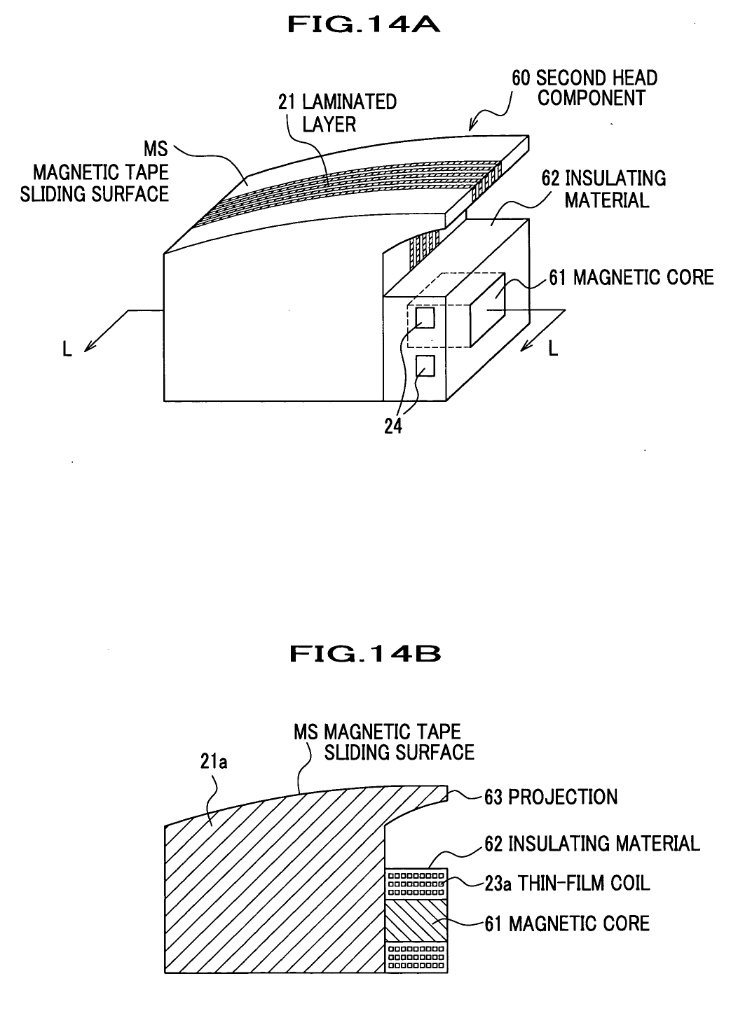

For example, the coil 23 in the first embodiment is a wire-wound coil, that is to say, a wire is wound around the magnetic core as shown in FIG. 1; however, the present invention is not limited to this embodiment, but rather the coil 23 may be a thin-film coil formed through patterning by the photolithography methods. This exemplary alternative embodiment is typically such as illustrated in FIGS. 14A and 14B, in which FIG. 14A shows a perspective view of a second head component 60, and FIG. 14B shows a sectional view of the second head component 60 taken along line L-L of FIG. 14A, assuming that this combined magnetic head is constructed by joining the second head component 60 as shown in FIGS. 14A and 14B with a first head component 10 as employed in the first embodiment (see FIG. 1).

The second head component 60 includes a laminated layer 21 like that which is provided in the second head component 20 (see also FIG. 4) in the first embodiment. To be more specific, the laminated layer 21 may be comprised of magnetic films 21a laminated in layers with non-magnetic films interleaved between the layers of the magnetic films 21a. The second head component 60 also includes a magnetic core 61, an insulating material 62 and a thin-film coil 23a. The magnetic core 61 is magnetically connected with magnetic films 21a of the second head component 60. The insulating material 62 is provided to enclose the magnetic core 61. The thin-film coil 23a is embedded in the insulating material 62, and formed in such a manner that the thin-film coil 23a is wound around the magnetic core 61. Electrode pads 24 for write head is provided in the second head component 60, and the thin-film coil 23a is electrically connected with the electrode pads 24 for write head.

The second head component 60 as thus constructed is joined with the first head component 10 as in FIG. 1 to form a combined magnetic head, in which a projection 63 formed at a magnetic-tape-sliding-surface (MS) side of the magnetic films 21a, as shown in FIG. 14B, tapers down toward the first head component 10 and distal end thereof as thus gradually narrowed is eventually in contact with the joint surface JS at a position opposed to the first shield layer 35a of the first head component 10 with the insulating film 12 as a write gap Gp placed therebetween, as shown in FIG. 5, while the magnetic core 61 formed to project at the opposite side (i.e., away from the magnetic tape sliding surface MS) of and toward the same direction as the above projection 63 is magnetically connected with the first shield layer 35a exposed at the joint surface of the first head component 10, as shown in FIG. 5.

The above-described alternative embodiment of the magnetic tape head includes the thin-film coil 23a that can be formed by the photolithography techniques, for example, by patterning a copper thin-film or other kinds of conductive metal foil films, and thus the thin-film photolithography method used in forming (or patterning) the thin-film coil allows line widths and spaces thereof down, and makes the wire finer than that of a coil made by winding a wire into a spiral shape. Accordingly, with this embodiment, the number of turns of the coil can be considerably increased. In addition, since the thin-film coil 23a of the combined magnetic head in this embodiment is embedded in the insulating material 62, the insulation defects in the coil can be obviated without fail. Moreover, the thin-film coil 23a may be formed by making use of a device for forming the laminated layer 21, such as a sputtering device, without the need for providing a separate wire-winding device. The use of existing equipment, as above, leads to saving the manufacturing costs of the combined magnetic head. It is also to be understood that the thin-film coil 23a may be provided in the insulating film 12 formed over the first shield layer 35a.

Furthermore, although the above discussion is extended on the premise that the MR head 30 includes the MR film 31c made of Permalloy™ (i.e., the magnetoresistive read element uses an AMR sensor), a GMR head having a spin-valve film, or a TMR head having a tunneling junction film may be used instead.

In conclusion, the present invention provides a combined magnetic head and fabrication method therefor, in which stronger read signals can be obtained and data stored with increasing recording densities can be encoded and decoded.

What is claimed is:

1. A combined magnetic head comprising:
an inductive head including a magnetic core having a plurality of magnetic films with non-magnetic films interleaved therebetween, a coil for inducing a magnetic flux in the magnetic core, and an insulator serving as a write gap at which the magnetic flux produces a flux leakage; and
a magnetoresistive head, wherein end faces of the magnetic films are disposed to face the write gap.

2. A combined magnetic head according to claim 1, wherein the coil is a thin-film coil.

3. A combined magnetic head according to claim 2, wherein the coil is formed by photolithography.

4. A combined magnetic head according to claim 1, wherein the magnetic core is made of sendust.

5. A combined magnetic head according to claim 1, wherein a magnetoresistive element used for the magnetoresistive head includes one of an anisotropic magnetoresistive film, a spin-valve film, and a tunneling magnetoresistive film.

6. A method of manufacturing a combined magnetic head, comprising the steps of:
fabricating a first head component, which includes forming a magnetoresistive element on a first substrate;
fabricating a second head component, which includes laminating a plurality of magnetic films and non-magnetic films alternately on a second substrate; and
joining the first head component and the second head component together.

7. A method of manufacturing a combined magnetic head according to claim 6, wherein the step of fabricating the second head component further includes:
forming a coil for inducing a magnetic flux in a magnetic core comprised of the laminated magnetic films; and
forming an insulator serving as a write gap at which the magnetic flux produces a flux leakage, and
wherein the end faces of the magnetic films are disposed to face the write gap.

8. A method of manufacturing a combined magnetic head according to claim 7, wherein the coil is formed into a thin-film coil by photolithography.

9. A method of manufacturing a combined magnetic head according to claim 7, wherein the magnetic core is made of sendust.

10. A combined magnetic head manufactured by the method of claim 6.

11. A helical-scan magnetic tape drive comprising the combined magnetic head of claim 1.

12. A helical-scan magnetic tape drive comprising the combined magnetic head of claim 10.
